(19) United States
(12) Patent Application Publication
(10) Pub. No.: US 2017/0141680 A1
(43) Pub. Date: May 18, 2017

(54) DC-DC CONVERTER WITH TRANSIENT CONTROL AND THE METHOD THEREOF

(71) Applicant: Chengdu Monolithic Power Systems Co., Ltd., Chengdu (CN)

(72) Inventors: Qian Ouyang, Zhejiang (CN); Xiaokang Wu, Zhejiang (CN); Lijie Jiang, Zhejiang (CN)

(21) Appl. No.: 15/344,429

(22) Filed: Nov. 4, 2016

(30) Foreign Application Priority Data
Nov. 12, 2015 (CN) 201510770698.X

(51) Int. Cl. H02M 3/04; H02M 1/08

(52) U.S. Cl. CPC H02M 3/04; H02M 1/08; H02M 2001/0009

(57) ABSTRACT

The present invention discloses a DC-DC converter with constant on time control. The DC-DC converter includes a transient unit to obtain the transient information of a current flowing through a power switching circuit, to slow down the variation of the output voltage, so as to eliminate the overshot issue.

### CROSS-REFERENCE TO RELATED APPLICATIONS

This application claims priority to and the benefit of Chinese Patent Application No. 201510770698.X, filed Nov. 12, 2015, which is incorporated herein by reference in its entirety.

### FIELD

The present invention relates to electronic circuits, more specifically, the present invention relates to DC-DC converter with COT (constant on time) control and the method thereof.

### BACKGROUND

Most electric devices such as notebook, desktop computer and PDA need a regulated voltage to power function blocks. DC-DC converters with COT control characterized with fast transient response and simple structure are widely used in the above fields. Typically, DC-DC converters with COT control need slope compensation to stabilize the output voltage.

A slope compensation signal has a fixed slope in prior art. It is reset to zero when a main power switch in the converter turns on. Then it increases with a fixed slope until the slope compensation signal is reset again when the output voltage of the converter drops to a sum of the slope compensation signal and a reference voltage. This process repeats during the operation of the converter.

However, if load step occurs (e.g. the load steps to heavy load from light load, or the load steps to light load from heavy load), the output voltage decreases rapidly and falls below the reference voltage in a short time period. FIG. 1 schematically shows time waveforms of the inductor current I_{L}, the switching control signal PWM, the output voltage V_{O}, the slope compensation signal Vsl, the reference voltage V_{REF} and the output current I_{O} in a typical DC-DC converter with COT control when the load suddenly steps to heavy load from light load, wherein the x axis represents time. As shown in FIG. 1, the load suddenly steps to heavy load from light load at time point t1. Then the slope compensation signal V_{S}l is reset to zero several times and a plurality of switching control signals PWM are generated in short time period (from time point t1 to time point t2). This plurality of switching control signals PWM causes the inductor current to rise rapidly. Then the inductor would store much more power than needed after the new steady state is reached. The redundant power would charge an output capacitor, which pumps the output voltage V_{O}, and causes an overshoot issue. In some worst situations, voltage ring back may occur.

### SUMMARY

It is an object of the present invention to provide an improved DC-DC converter with transient control, which solves the above problems.

In accomplishing the above and other objects, there has been provided, in accordance with an embodiment of the present invention, a DC-DC converter with transient control, comprising: a power switching circuit, configured to receive an input voltage and to provide an output voltage; a transient unit, configured to generate a transient current signal indicative of the transient information of a current flowing through the power switching circuit; a comparing circuit, configured to generate a set signal based on a reference voltage, a feedback voltage indicative of the output voltage, a slope compensation signal and the transient current signal; and a logical control circuit, configured to generate a switching control signal to control the operation of the power switching circuit based on the set signal.

In addition, there has been provided, in accordance with an embodiment of the present invention, a DC-DC converter with transient control, comprising: a power switching circuit, configured to receive an input voltage and to provide an output voltage; a resistor, having a first end and a second end, wherein the first end is configured to receive a current sense signal indicative of the current flowing through the power switching circuit; a capacitor, coupled between the second end of the resistor and a reference ground; a comparing circuit, configured to generate a set signal based on a reference voltage, a feedback voltage indicative of the output voltage, a slope compensation signal, the current sense signal and a voltage across the capacitor; and a logical control circuit, configured to generate a switching control signal to control the operation of the power switching circuit based on the set signal.

Furthermore, there has been provided, in accordance with an embodiment of the present invention, a method used in a DC-DC converter, the DC-DC converter including a power switching circuit configured to receive an input voltage and generate an output voltage, the method comprising: detecting whether the DC-DC converter is in steady state condition or in transient state condition; comparing a sum of a slope compensation signal and a reference voltage with the feedback voltage to generate a set signal when the DC-DC converter is in steady state condition; and generating a transient current signal indicative of the transient information of a current flowing through the power switching circuit, and comparing a sum of the slope compensation signal and the reference voltage with a sum of the feedback voltage and the transient current signal to generate the set signal when the DC-DC converter is in transient state condition.

### BRIEF DESCRIPTION OF THE DRAWINGS

FIG. 1 schematically shows time waveforms of the inductor current I_{L}, the switching control signal PWM, the output voltage V_{O}, the slope compensation signal V_{SL}, the reference voltage V_{REF} and the output current I_{O} in a typical DC-DC converter with COT control when the load suddenly steps to heavy load from light load.

FIG. 2 schematically shows a DC-DC converter 100 in accordance with an embodiment of the present invention.

FIG. 3 schematically shows a circuit configuration of the transient unit 104 in the DC-DC converter 100 in FIG. 2 in accordance with an embodiment of the present invention.

FIG. 4 schematically shows a circuit configuration of the transient unit 104 in the DC-DC converter 100 in FIG. 2 in accordance with an embodiment of the present invention.

FIG. 5 schematically shows a circuit configuration of the comparing circuit 105 in the DC-DC converter 100 in FIG. 2 in accordance with an embodiment of the present invention.

FIG. 6 schematically shows a DC-DC converter 200 in accordance with an embodiment of the present invention.

FIG. 7 schematically shows a circuit configuration of the comparing circuit 105 in the DC-DC converter 200 in FIG. 6 in accordance with an embodiment of the present invention.

FIG. 8 schematically shows a circuit configuration of the power switching circuit 103 in accordance with an embodiment of the present invention.

FIG. 9 schematically shows a flow chart 300 of a method used in a DC-DC converter in accordance with an embodiment of the present invention.

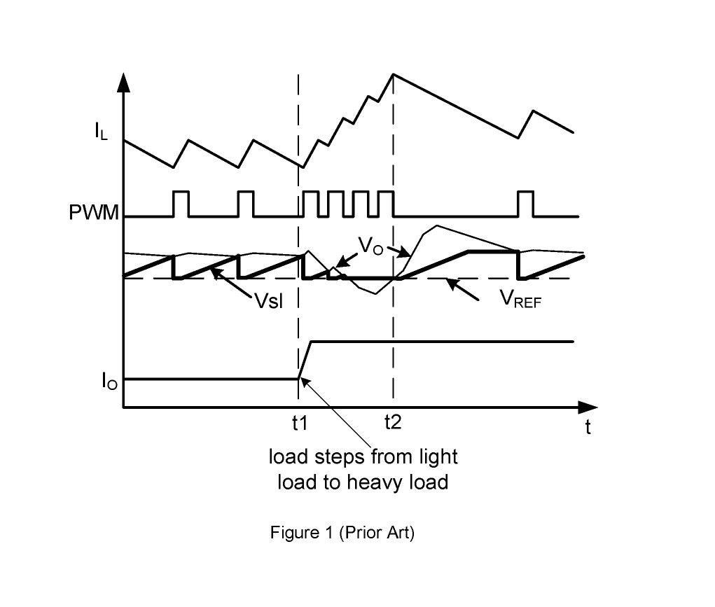

The use of the similar reference label in different drawings indicates the same of like components.

### DETAILED DESCRIPTION

Embodiments of circuits for DC-DC converter are described in detail herein. In the following description, some specific details, such as example circuits for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

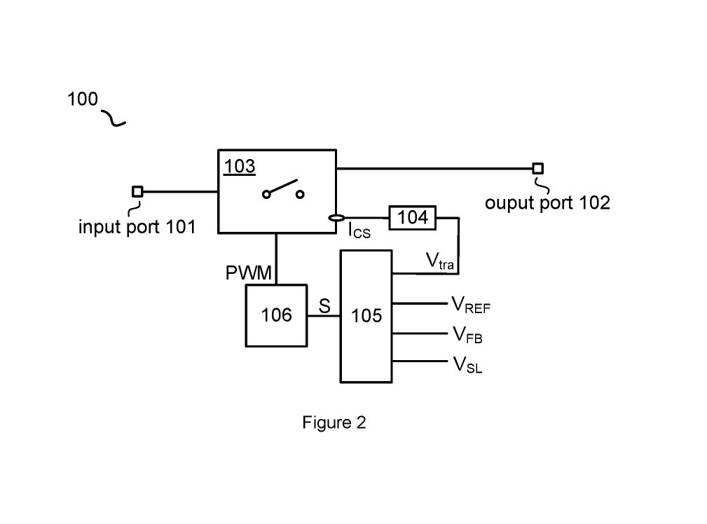

FIG. 2 schematically shows a DC-DC converter 100 in accordance with an embodiment of the present invention. In the example of FIG. 2, the DC-DC converter 100 comprises: an input port 101, configured to receive an input voltage Vin; an output port 102, configured to provide an output voltage V_{O}; a power switching circuit 103, coupled between the input port 101 and the output port 102; a control circuit, configured to provide a switching control signal PWM, to control the operation of the power switching circuit 103, the control circuit including: a transient unit 104, configured to receive a current sense signal I_{CS} indicative of a current flowing through the power switching circuit 103, to generate a transient current signal Vₜᵣₐ; a comparing circuit 105, configured to receive a reference voltage V_{REF}, a feedback voltage V_{FB} indicative of the output voltage V_{O}, a slope compensation signal V_{SL} and the transient current signal Vₜᵣₐ, to generate a set signal S; and a logical control circuit 106, configured to receive the set signal S, to generate a switching control signal PWM; wherein when a sum of the feedback voltage V_{FB} and the transient current signal Vₜᵣₐ is less than a sum of the reference voltage V_{REF} and the slope compensation signal V_{SL} (i.e. below expression (1)), the set signal S goes high, and the switching control signal PWM is triggered by the set signal S to turn on the power switching circuit 103.

V_{FB}+Vₜᵣₐ<V_{REF}+V_{SL} (1)

In one embodiment, the current sense signal I_{CS} may be a current signal or a voltage signal.

In one embodiment, the slope compensation signal V_{SL} is reset to zero and increases with a fixed slope when a main power switch in the power switching circuit 103 turns on.

In one embodiment, the transient current signal Vₜᵣₐ generated by the transient unit 104 is indicative of the transient information (i.e. the AC component) of the current sense signal I_{CS}.

During the operation of the DC-DC converter, when the load step occurs (e.g. the load jumps to heavy load from light load very fast and within a short period of time), the output voltage V_{O} decreases. The frequency of the switching control signal PWM increases, and the current flowing through the power switching circuit 103 increases, i.e. the current sense signal I_{CS} increases. The transient current signal Vₜᵣₐ also increases. Thus the variation of the output voltage V_{O} slows down according to expression (1). As a result, the set signal postpones triggering the switching control signal PWM, which reduces the pulses of the switching control signal PWM. So the energy stored in the inductor is reduced during the load step, and the overshoot is eliminated, which ensures the system stability.

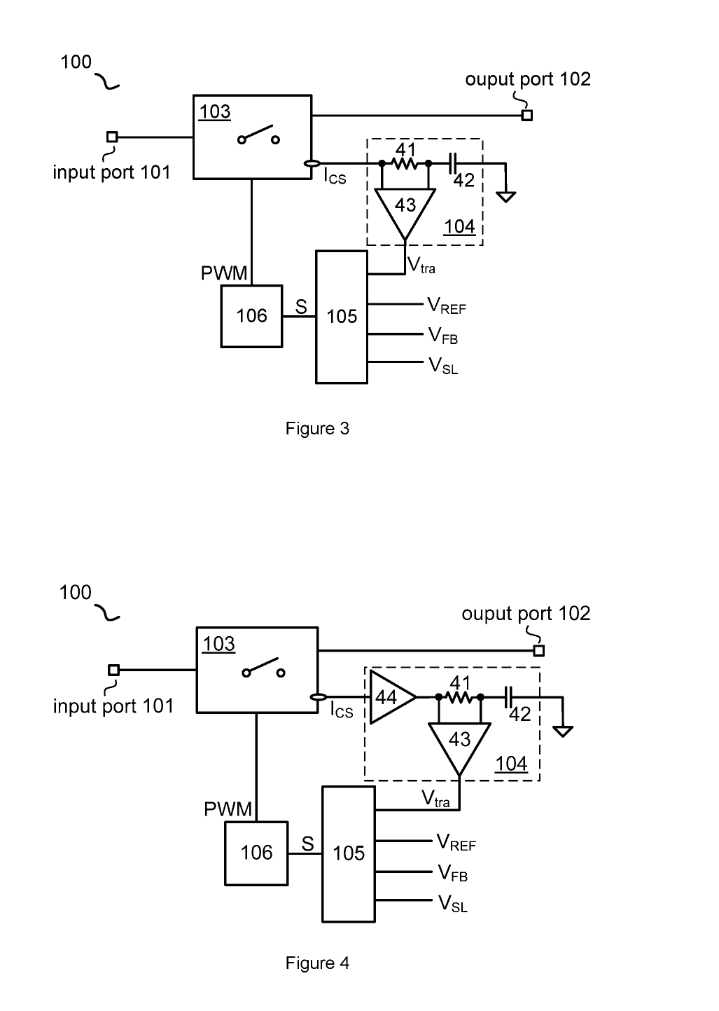

FIG. 3 schematically shows a circuit configuration of the transient unit 104 in the DC-DC converter 100 in FIG. 2 in accordance with an embodiment of the present invention. In the example of FIG. 3, the transient unit 104 comprises: a resistor 41, having a first end and a second end, wherein the first end is configured to receive the current sense signal I_{CS}; a capacitor 42, coupled between the second end of the resistor 41 and a reference ground; and an operation amplifier 43, coupled crossover the resistor 41 to receive a voltage across the resistor 41, to generate the transient current signal Vₜᵣₐ.

When the system is in operation, if the load step occurs (e.g. the load jumps to heavy load from light load), the current sense signal I_{CS} increases. Then the voltage across the resistor 41 also increases, i.e. the transient current signal Vₜᵣₐ increases. According to expression (1), the variation of the output voltage V_{O} slows down, and the set signal postpones triggering the switching control signal PWM, which reduces the pulses of the switching control signal PWM. So the energy stored in the inductor is reduced during the load step, and the overshoot is eliminated as discussed above. In steady state, due to the existence of the capacitor 42, the average voltage across the resistor 41 is zero. So the transient current signal Vₜᵣₐ provided by the transient unit 104 reflects the transient information of the current sense signal I_{CS}. That is, the transient current signal Vₜᵣₐ reflects the transient information (the alternating information) of the current flowing through the power switching circuit 103.

FIG. 4 schematically shows a circuit configuration of the transient unit 104 in the DC-DC converter 100 in FIG. 2 in accordance with an embodiment of the present invention. The transient unit 104 in FIG. 4 is similar to that in FIG. 3, with a difference that the transient unit 104 in FIG. 4 further comprises: a current-voltage converter 44, wherein the resistor 41 is configured to receive the current sense signal I_{CS} via the current-voltage converter 44. When the current sense signal I_{CS} is a current signal, the current-voltage converter 44 converts the current form into voltage form; and then it delivers the voltage form to the first end of the resistor 41.

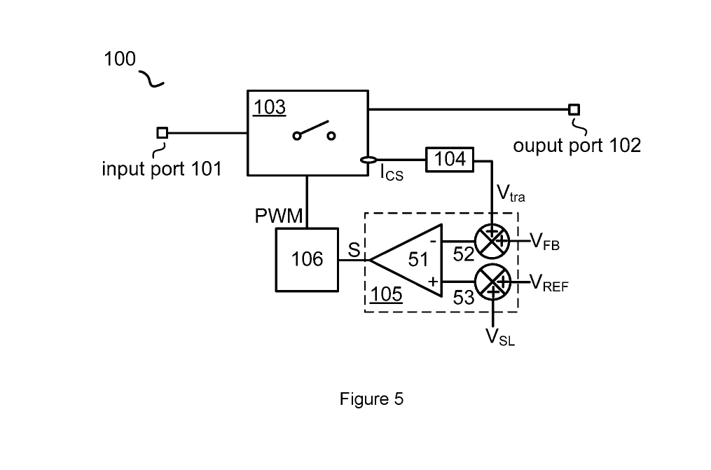

FIG. 5 schematically shows a circuit configuration of the comparing circuit 105 in the DC-DC converter 100 in FIG. 2 in accordance with an embodiment of the present invention. In the example of FIG. 5, the comparing circuit 105 comprises: a comparator 51, having a first input terminal, a second input terminal and an output terminal; a first adder 52, configured to receive the transient current signal Vₜᵣₐ and the feedback voltage V_{FB}, to execute add operation on the transient current signal Vₜᵣₐ and the feedback voltage V_{FB}, and deliver the add result to the first input terminal of the comparator 51; and a second adder 53, configured to receive the reference voltage V_{REF} and the slope compensation signal V_{SL}, to execute add operation on the reference voltage V_{REF} and the slope compensation signal V_{SL}, and deliver the add result to the second input terminal of the comparator 51; wherein the comparator 51 compares the signal at its first input terminal with that at its second input terminal to generate the set signal S.

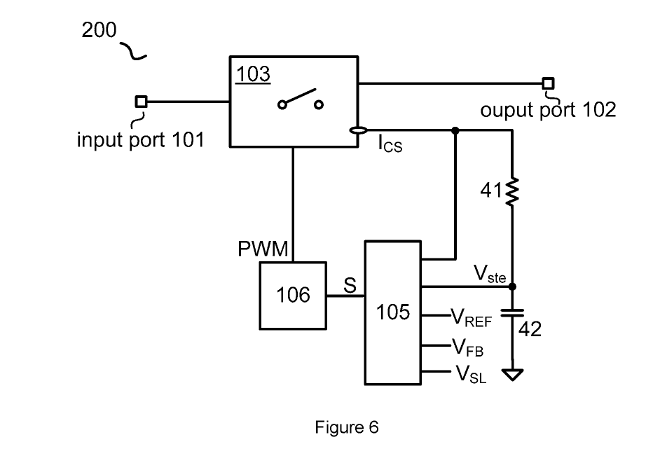

FIG. 6 schematically shows a DC-DC converter 200 in accordance with an embodiment of the present invention. In the example of FIG. 6, the DC-DC converter 200 comprises: an input port 101, configured to receive an input voltage Vin; an output port 102, configured to provide an output voltage V_{O}; a power switching circuit 103, coupled between the input port 101 and the output port 102; a control circuit, configured to provide a switching control signal PWM, to control the operation of the power switching circuit 103, the control circuit including: a resistor 41, having a first end and a second end, wherein the first end is configured to receive the current sense signal I_{CS}; a capacitor 42, coupled between the second end of the resistor 41 and a reference ground, the voltage across the capacitor 42 being a steady current signal Vₛₜₑ; a comparing circuit 105, configured to receive a reference voltage V_{REF}, a feedback voltage V_{FB} indicative of the output voltage V_{O}, a slope compensation signal V_{SL} and the steady current signal Vₛₜₑ, to generate a set signal S; and a logical control circuit 106, configured to receive the set signal S, to generate the switching control signal PWM, to control the operation of the power switching circuit 103.

In one embodiment, if the current sense signal I_{CS} is in current form, the DC-DC converter 200 further comprises a current-voltage converter as shown in FIG. 4, and the resistor 41 is configured to receive the current sense signal I_{CS} via the current-voltage converter.

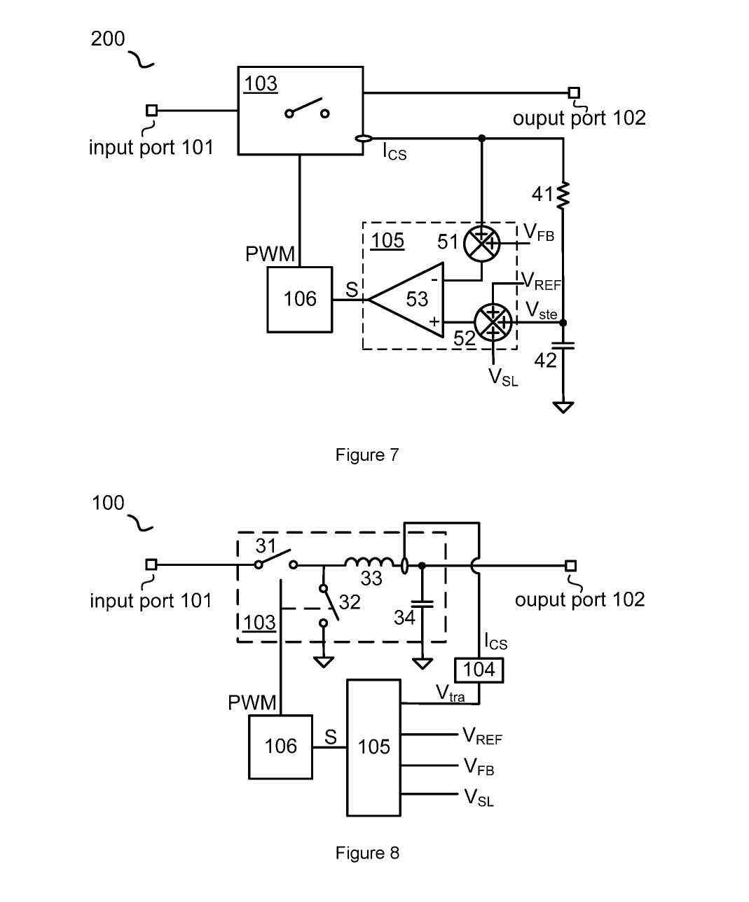

FIG. 7 schematically shows a circuit configuration of the comparing circuit 105 in the DC-DC converter 200 in FIG. 6 in accordance with an embodiment of the present invention. In the example of FIG. 7, the comparing circuit 105 comprises: a comparator 51, having a first input terminal, a second input terminal and an output terminal; a first adder 52, configured to receive the current sense signal I_{CS} and the feedback voltage V_{FB}, to execute add operation on the current sense signal I_{CS} and the feedback voltage V_{FB}, and deliver the add result to the first input terminal of the comparator 51; and a second adder 53, configured to receive the reference voltage V_{REF}, the slope compensation signal V_{SL} and the steady current signal Vₛₜₑ, to execute add operation on the reference voltage V_{REF}, the slope compensation signal V_{SL} and the steady current signal Vₛₜₑ, and deliver the add result to the second input terminal of the comparator 51; wherein the comparator 51 compares the signal at its first input terminal with that at its second input terminal to generate the set signal S.

When the system is in operation, the current sense signal I_{CS} is delivered to the first input terminal of the comparator 53 via the first adder 51, and is delivered to the second input terminal of the comparator 53 via the resistor 41, the capacitor 42 and the second adder 52. So the current sense signal I_{CS} is counteracted in steady state condition. But in transient state condition, e.g. when the load suddenly jumps to heavy load from light load, the current sense signal I_{CS} increases rapidly. Because of the existence of the capacitor, the voltage across the capacitor 42 (i.e. the transient current signal Vₛₜₑ) cannot change so fast, so the transient information of the current sense signal I_{CS} is delivered to the first input terminal of the comparator 53. As a result, the variation of the output voltage V_{O} slows down, and the set signal postpones triggering the switching control signal PWM, which reduces the pulses of the switching control signal PWM. Thus the energy stored in the inductor is reduced during the load step, and the overshoot is eliminated.

FIG. 8 schematically shows a circuit configuration of the power switching circuit 103 in accordance with an embodiment of the present invention. In the example of FIG. 8, the power switching circuit 103 comprises a typical buck circuit. That is, the power switching circuit 103 comprises: a high side power switch 31, a low side power switch 32, an inductor 33 and an output capacitor 34 connected as shown. The configuration of buck circuit is well known in the art, and will not be discussed in detail for brief illustration,

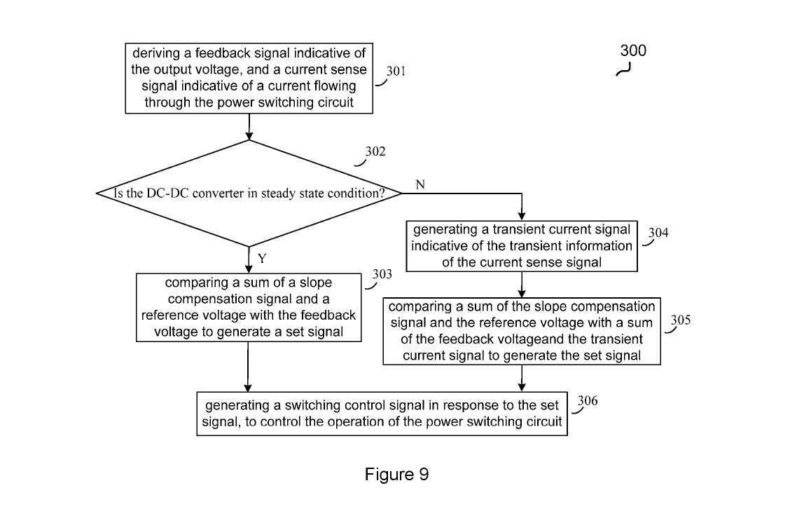

FIG. 9 schematically shows a flow chart 300 of a method used in a DC-DC converter in accordance of the present invention. The DC-DC converter including a power switching circuit configured to receive an input voltage and generate an output voltage, the method comprises:

Step 301, deriving a feedback signal indicative of the output voltage, and a current sense signal indicative of a current flowing through the power switching circuit.

Step 302, detecting whether the DC-DC converter is in steady state condition or not, if the DC-DC converter is in steady state condition, go to step 303; and if the DC-DC converter is in transient state condition, go to step 304.

Step 303, comparing a sum of a slope compensation signal V_{SL} and a reference voltage V_{REF} with the feedback voltage V_{FB} to generate a set signal.

Step 304, generating a transient current signal Vₜᵣₐ indicative of the transient information of the current sense signal.

Step 305, comparing a sum of the slope compensation signal V_{SL} and the reference voltage V_{REF} with a sum of the feedback voltage V_{FB} and the transient current signal to generate the set signal.

Step 306, generating a switching control signal in response to the set signal, to control the operation of the power switching circuit.

It is to be understood in these letters patent that the meaning of “A” is coupled to “B” is that either A and B are connected to each other as described below, or that, although A and B may not be connected to each other as described above, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

This written description uses examples to disclose the invention, including the best mode, and also to enable a person skilled in the art to make and use the invention. The patentable scope of the invention may include other examples that occur to those skilled in the art.

What is claimed is:

1. A DC-DC converter with transient control, comprising:
a power switching circuit, configured to receive an input voltage and to provide an output voltage;
a transient unit, configured to generate a transient current signal indicative of the transient information of a current flowing through the power switching circuit;
a comparing circuit, configured to generate a set signal based on a reference voltage, a feedback voltage indicative of the output voltage, a slope compensation signal and the transient current signal; and
a logical control circuit, configured to generate a switching control signal to control the operation of the power switching circuit based on the set signal.

2. The DC-DC converter of claim 1, wherein the transient unit comprises:
a resistor, having a first end and a second end, wherein the first end is configured to receive a current sense signal indicative of the current flowing through the power switching circuit;
a capacitor, coupled between the second end of the resistor and a reference ground; and
an operation amplifier, coupled crossover the resistor to receive a voltage across the resistor, to generate the transient current signal.

3. The DC-DC converter of claim 2, wherein the transient unit further comprises:
a current-voltage converter, wherein the resistor is configured to receive the current sense signal via the current-voltage converter.

4. The DC-DC converter of claim 1, wherein the comparing circuit comprises:
a comparator, configured to generate the set signal by comparing a sum of the transient current signal and the feedback voltage with a sum of the reference voltage and the slope compensation signal.

5. The DC-DC converter of claim 4, wherein when the sum of the feedback voltage and the transient current signal is less than the sum of the reference voltage and the slope compensation signal, the switching control signal is triggered to turn on the power switching circuit.

6. The DC-DC converter of claim 4, wherein the comparing circuit further comprises:
a first adder, configured to execute add operation on the transient current signal and the feedback voltage; and
a second adder, configured to execute add operation on the reference voltage and the slope compensation signal.

7. A DC-DC converter with transient control, comprising:
a power switching circuit, configured to receive an input voltage and to provide an output voltage;
a resistor, having a first end and a second end, wherein the first end is configured to receive a current sense signal indicative of the current flowing through the power switching circuit;
a capacitor, coupled between the second end of the resistor and a reference ground;
a comparing circuit, configured to generate a set signal based on a reference voltage, a feedback voltage indicative of the output voltage, a slope compensation signal, the current sense signal and a voltage across the capacitor; and
a logical control circuit, configured to generate a switching control signal to control the operation of the power switching circuit based on the set signal.

8. The DC-DC converter of claim 7, further comprising:
a current-voltage converter, wherein the resistor is configured to receive the current sense signal via the current-voltage converter.

9. The DC-DC converter of claim 7, wherein the comparing circuit comprises:
a comparator, configured to generate the set signal by comparing a sum of the feedback voltage and the current sense signal with a sum of the reference voltage, the voltage across the capacitor and the slope compensation signal.

10. The DC-DC converter of claim 9, wherein when the sum of the feedback voltage and the current sense signal is less than the sum of the reference voltage, the voltage across the capacitor and the slope compensation signal, the switching control signal is triggered to turn on the power switching circuit.

11. The DC-DC converter of claim 9, wherein the comparing circuit further comprises:
a first adder, configured to execute add operation on the feedback voltage and the current sense signal; and
a second adder, configured to execute add operation on the reference voltage, the steady current signal and the slope compensation signal.

12. A method used in a DC-DC converter, the DC-DC converter including a power switching circuit configured to receive an input voltage and generate an output voltage, the method comprising:
detecting whether the DC-DC converter is in steady state condition or in transient state condition;
comparing a sum of a slope compensation signal and a reference voltage with the feedback voltage to generate a set signal when the DC-DC converter is in steady state condition; and
generating a transient current signal indicative of the transient information of a current flowing through the power switching circuit, and comparing a sum of the slope compensation signal and the reference voltage with a sum of the feedback voltage and the transient current signal to generate the set signal when the DC-DC converter is in transient state condition.
